(19) United States
(12) Patent Application Publication
(10) Pub. No.: US 2014/0136354 A1
(43) Pub. Date: May 15, 2014

(54) MOBILE PAYMENT TRANSACTION PROCESSING VIA UNATTENDED TERMINAL

(71) Applicant: Heartland Payment Systems, Inc., Princeton, NJ (US)

(72) Inventors: Frederick Scott Emery, Lithia, FL (US); Zdravko Yordanov Aleksandrov, Toronto (CA); Haris Kahrimanovic, Colorado Springs, CO (US); Miroslav Stanecek, Monument, CO (US)

(73) Assignee: Heartland Payment Systems, Inc., Princeton, NJ (US)

(21) Appl. No.: 14/073,955

(22) Filed: Nov. 7, 2013

Related U.S. Application Data
(60) Provisional application No. 61/796,368, filed on Nov. 8, 2012.

(51) Int. Cl. G06Q 20/40; G06Q 20/20

(52) U.S. Cl. CPC G06Q 20/40; G06Q 20/202
USPC 705/21; 705/44

(57) ABSTRACT

A mobile payment application loaded upon a user device allows a user to perform mobile payment transactions for the purchase of a product and/or service via an unattended terminal over a network. The networked unattended terminal is operationally coupled with a mechanism, such as a vending machine, for delivering the purchased product and/or service to the user.

### CROSS REFERENCE TO RELATED APPLICATIONS

This application claims the benefit of U.S. Provisional Application No. 61/796,368, filed Nov. 8, 2012, which is hereby incorporated herein by reference in its entirety.

### BACKGROUND

The invention relates to technology for authorizing the delivery of products and/or services from a delivery mechanism in response to payment transactions initiated by a user, and more particularly to technology for authorizing the delivery of products and/or services from a delivery mechanism in response to payment transactions initiated by a user via a mobile communication device.

Technology for assisting merchants with the delivery of products and/or services in response to payment are known in the art. Early forms of such technology include cash registers (including a cash drawer) and coin-operated vending machines. Over time, consumers' preferred methods of payment evolved and as they did, the vending and/or service delivery technology evolved with them. For example, as the price of vended items increased, it became less desirable to pay for such items with coins due to the large quantity of them that were required to make a purchase. In response, technology was developed that enabled vending machines to accept paper currency.

More recently, consumers have been transacting more of their purchases by means of credit and debit cards, making it less necessary to carry cash with them. Not wanting to lose potential sales, vending machine technology and point of sale terminals have been adapted to accept these forms of payment as well.

In each of these various technologies, a common feature over time has been the user's physical interaction with an apparatus to initiate the payment transaction. Taking the non-limiting example of a vending machine, at first payment involved depositing one or more coins into a slot. Later technology had the user inserting paper currency into the slot of a currency reader. More recently, vending machines have credit/debit card readers that require the user to manually swipe the card to effect a reading of information encoded on the card's magnetic strip, or alternatively have an automated swiping process that is initiated when the card is inserted into a card slot.

A similar showing can be made with respect to the evolution of other vending/service technology, such as from early cash registers to today's point of sale (POS) terminals.

Preferred modes of payment continue to evolve. For example, more and more of today's consumers find it handy to effect purchases at merchant web sites accessed over the Internet. Such payment transactions are carried out entirely by electronic means (e.g., by having the user input payment information by means of a device keyboard), requiring neither physical currency nor a physical credit or debit card.

The inventors of the technology described herein have recognized the desirability of providing a similar convenience when a consumer wants to purchase a service or vended item from an unattended machine, but conventional technology insists on a physical interaction between the purchaser and the machine in order to initiate payment (e.g., by means of depositing physical currency or insertion/swiping of a physical credit/debit card).

In view of the above, it is therefore desirable to provide an automated mechanism for carrying out payment transactions in a manner even more convenient to the consumer.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof. Also, as used herein the term “exemplary” means serving as one illustration out of any number of possible illustrations. In accordance with one aspect of the present invention, the foregoing and other objects are achieved in methods and apparatuses for vending a product and/or service. Vending the product involves a user device transmitting, via a first data network, a transaction request that includes a terminal identifier and a user account identifier, wherein the user account identifier uniquely identifies a user account in a payment system. A component coupled to the first data network and to a second data network receives the transaction request and uses the terminal identifier to direct transaction request information to an unattended terminal coupled to the second network, wherein the transaction request information is derived from the transaction request and includes information identifying the user account. The unattended terminal receives the transaction request information from the second data network and sends a payment authorization request to the payment system, wherein the payment authorization request includes the information identifying the user account. The unattended terminal also receives a payment authorization response to the payment authorization request and acts in accordance with information included in the authorization response, including enabling a product and/or service to be vended in response to the authorization response information indicating that a payment has been authorized by the payment system.

In an aspect of some but not necessarily all embodiments, the first data network is an open data network and the second data network is a closed data network.

In an aspect of some but not necessarily all embodiments, the unattended terminal is operatively coupled to a vending machine; and enabling the product and/or service to be vended comprises the unattended terminal sending vending control signals to the vending machine, wherein the vending control signals enable the vending machine to vend the product and/or service.

In an aspect of some but not necessarily all embodiments, the unattended terminal sending the payment authorization request to the payment system comprises the unattended terminal executing one or more transaction functions that are performed in response to receiving, as a result of a card swiping, information stored on a physical card.

In an aspect of some but not necessarily all embodiments, the unattended terminal is a point of sale terminal, wherein the point of sale terminal sending the payment authorization request to the payment system comprises:
displaying a list of authorized mobile payment users;
receiving, through a point of sale terminal user interface, a selection of one of the displayed authorized mobile payment users; and
transmitting the payment authorization request to the payment system.

Further in such embodiments, the point of sale terminal sends an initial transaction request to the payment system that informs the payment system that a user of the user device intends to submit a transaction request through the point of sale terminal. The point of sale terminal offers item selections to the user via a point of sale terminal interface and receives item selections via the point of sale terminal interface. The point of sale terminal causes a queue of waiting payments to be created and stored in a database of the payment system, and causes the payment system to process the queue of waiting payments and to send the processed queue of waiting payments to the user device. The user device receives input from the user that indicates acceptance of the processed queue of waiting payments, and consequently sends a confirmation message to the payment system. The payment system debits the user account and credits a vendor account based on the processed queue of waiting payments, and confirms to the point of sale terminal that the queue waiting payments has been paid.

In an aspect of some but not necessarily all embodiments, the user device receives, on a user device input interface, information representative of the terminal identifier.

In an aspect of some but not necessarily all embodiments, the user device presents, on a user device output interface, a list of unattended terminals; and receives, on a user device input interface, a user selection from the list of terminals, wherein the user selection indicates the terminal identifier. The list of unattended terminals can, in some embodiments, be a list of unattended terminals that have been recently used by a user of the user device.

In an aspect of some but not necessarily all embodiments, geographic positioning circuitry is used to identify a geographic position of the user device. The user device displays on a user device output interface a map that includes the geographic position of the user device; and presents, on the user device output interface a graphic depiction of unattended terminals at positions on the map that correspond to respective geographic positions of the respective unattended terminals.

In an aspect of some but not necessarily all embodiments, the user device optically receives an image of a QR Code®, wherein the QR Code® is displayed at a physical location proximate to the unattended terminal and/or at a physical location proximate to a vending machine that is operatively coupled to the unattended terminal.

In an aspect of some but not necessarily all embodiments, the user device receives, from the payment system, information about a user of the user device; creates, from the received information about the user of the user device, a virtual identification card; and displays the virtual identification card on an output interface of the user device.

In an aspect of some but not necessarily all embodiments, the user device presents on a user device output interface, an image representing a readiness of the user device to initiate a mobile payment transaction; receives data on a user device input interface and, by processing the received data, detects that a user of the user device has performed a swiping motion on the user device input interface. In such embodiments, the user device transmitting the transaction request is initiated in response to the user device detecting that the user of the user device has performed the swiping motion on the user device input interface.

### BRIEF DESCRIPTION OF THE DRAWINGS

The objects and advantages of the invention will be understood by reading the following detailed description in conjunction with the drawings in which:

FIG. 1 is a representative illustration of a system for performing a mobile payment transaction using an unattended terminal in accordance with an exemplary embodiment of the invention.

FIG. 2 is a representative illustration of a system for performing a mobile payment transaction in accordance with an exemplary embodiment of the current invention.

FIG. 3 is a block diagram illustrating a method for the performance of a vending transaction through a vending device operationally coupled with an unattended terminal.

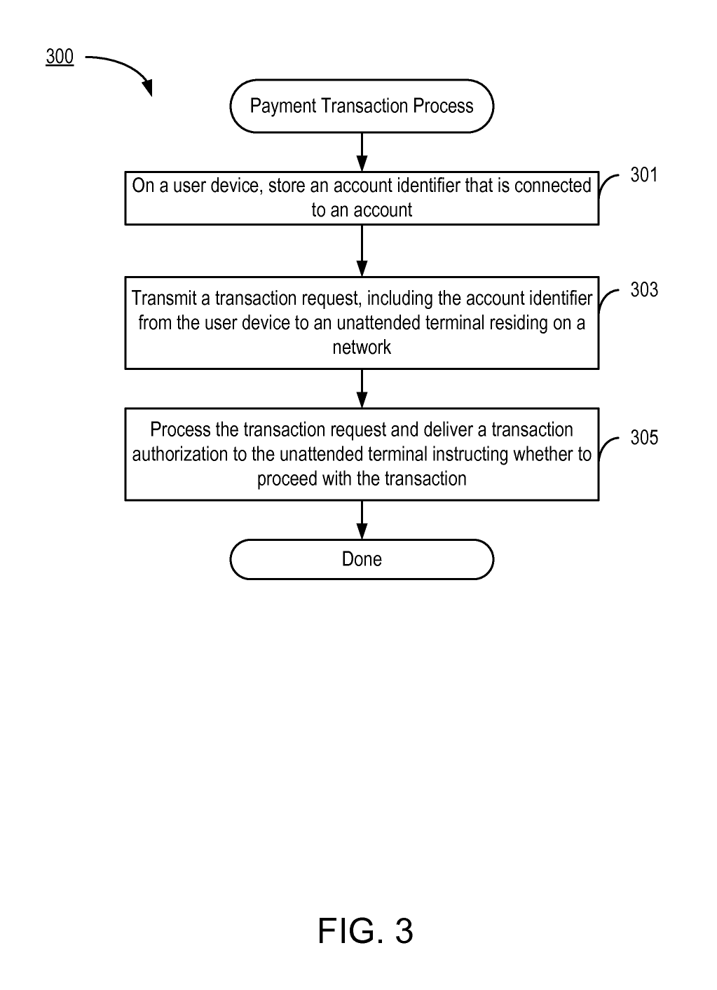

FIG. 4 is an illustration of a display screen presented upon a user device loaded with a mobile payment application of the current invention.

FIG. 5 is, in one respect, a flow chart of steps/processes performed by circuitry in accordance with some but not necessarily all exemplary embodiments of the invention relating to a mobile payment system in the context of a commercial dining environment.

FIG. 6 is a schematic diagram of an exemplary arrangement that enables the mobile payment system to effect mobile payments directed to third party unattended terminals or devices, which are not directly coupled to the campus's closed network.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors and/or a processor in combination with one or more portions of processor software stored in storage locations of the processor's non-transitory memory from which the processor retrieves and carries out the retrieved instructions). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

Embodiments consistent with the invention provide a system for processing mobile payment transactions over a closed network for delivery of products and/or services from a delivery mechanism residing on the network. The delivery mechanism, such as a vending device or POS device, is operationally coupled with an unattended terminal communicatively linked to the network. It may be the case that mobile payment transaction capabilities through an unattended terminal residing on or over a network have not been provided by the existing state of the art in the field. In an exemplary process performed by embodiments consistent with the invention, a user may select a product and/or service to be vended from the delivery mechanism (e.g., vending device). The user then communicates a transaction request, which can include an account identifier (account ID) and other relevant transaction data, to the unattended terminal which then processes the transaction request over the network. One or more servers coupled to the network complete the transaction process by providing a transaction authorization to the unattended terminal which determines whether the requested product and/or service is authorized to be sold to the user or not.

A mobile payment processing system is based on a campus network communicatively coupled with an unattended terminal, an account system and a mobile payment enabled computing apparatus. The mobile payment enabled computing apparatus is a “user device”, such as a mobile phone loaded with a mobile payment application, that allows a user to communicate a transaction request to the campus network. The unattended terminal is operationally coupled with a machine that provides for the delivery of a product and/or service to the user.

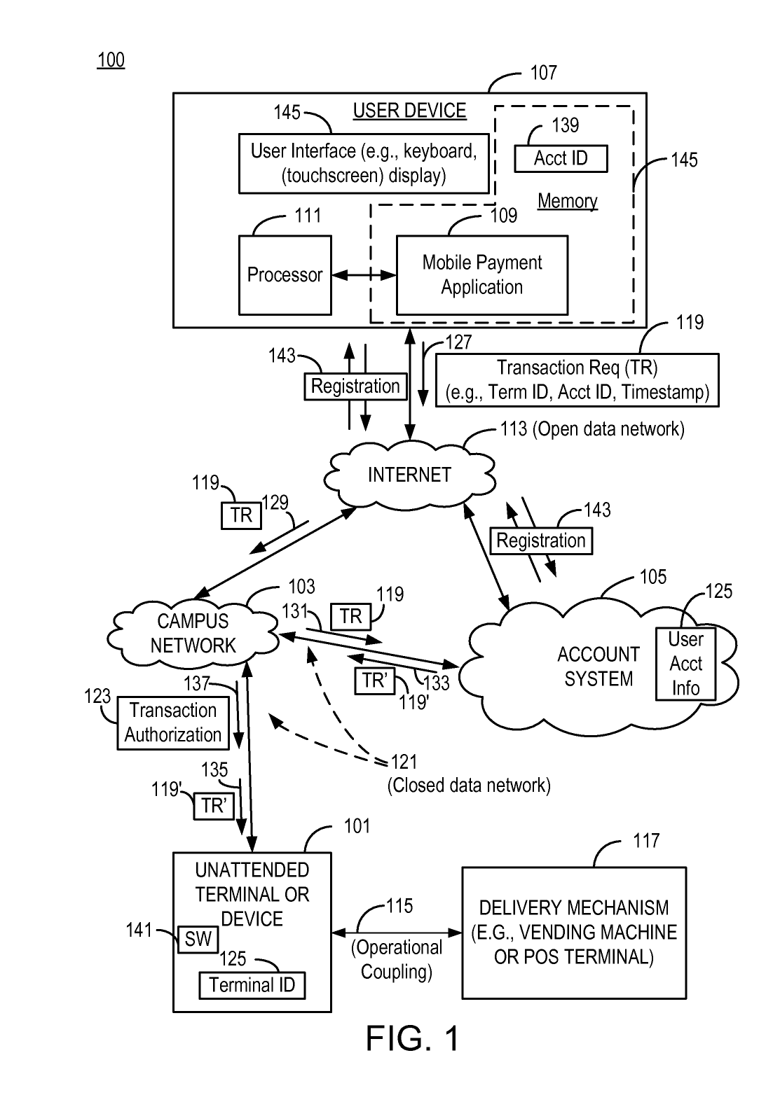

FIG. 1 is a representative illustration of an exemplary system 100 for performing a mobile payment transaction using an unattended terminal 101 in accordance with an exemplary embodiment of the invention. The mobile payment processing system 100 is based on a campus network 103 communicatively coupled via a closed data network 121 with the unattended terminal 101 and an account system 105. The campus network 103 is also communicatively coupled via an open network, such as the Internet 113, with a mobile payment enabled computing apparatus 107. The mobile payment enabled computing apparatus 107 is a “user device”, such as a mobile phone loaded with a mobile payment application 109, that, when run by a processor 111 in the user device, allows a user to communicate 127, 129 a transaction request 119 to the campus network 103 via the open data network (e.g., Internet) 113. The unattended terminal 101 is operationally coupled 115 with a machine 117 that provides for the delivery of a product and/or service to the user.

In one aspect of this exemplary embodiment, the mobile payment processing system 100 is based on the mobile payment enabled computing apparatus 107, which stores and transmits 127, 129 to the campus network 103, a transaction request 119 for the delivery of a product and/or service from the machine 117. Based on the transaction request 119, the campus network 103 communicates 131, 133, 135 (via the closed data network 121) with the account system 105 and with the unattended terminal 101 that is operationally coupled with the machine 117 for the delivery of the product and/or service.

In another aspect of this exemplary embodiment, the mobile payment processing system 100 is based on the unattended terminal 101 operationally coupled 115 with the machine 117 capable of delivering a user selected product and/or service. The unattended terminal 101 receives 137 a transaction authorization 123 from the campus network 103, regarding the transaction request 119 received from the mobile payment enabled computing apparatus 107, instructing the terminal 101 to sell or not sell the user selected product and/or service.

The mobile payment processing system 100 provides the ability to process an electronic payment transaction directed to an unattended terminal 101 without the use of a swipe card, such as a credit card, debit card, or other payment tool that presents account information within a magnetic stripe. Generally, the transactions handled by this system can be vending transactions, wherein a user is requesting the delivery of a product and/or service that is provided by a vending machine. It is contemplated that the system enables various other transactions, wherein an electronic payment is made by the user for the delivery of a product and/or service, from a machine, device, or other delivery mechanism. Other delivery mechanisms may include various automated and/or manual item selection and delivery mechanisms and environments.

In a vending environment, a user identifies a product and/or service (the “item”) that they desire to have delivered to them. The item is made available for user purchase by a vending machine. The vending machine is operationally coupled with an unattended terminal which resides on (is communicatively coupled with other computing devices over) a campus network. The campus network being a closed network that enables mobile payment transactions for networked vending machines, which includes those vending machines whose device number or device ID is recognized by the network. The unattended terminal 101 identifies itself and the vending machine 117 to which it is operationally coupled to the campus network via a terminal ID 125.

The user has a mobile payment enabled computing apparatus (the “user device”) 107 that allows the user to register a user account on the device 107 and transmit a transaction request 119 to the campus network 103. The transaction request 119 can comprise a terminal ID, an account identifier 139 and timestamp. The account identifier 139 is a digital representation established on the user's device of a user's financial/payment account recognized and able to be accessed by the campus network 103. The user's payment account (the “account”) is registered upon the user device 107, thereby associating the account identifier 139 with the account. The account registration authenticates the user account to the network and establishes the validity of the use of the account in a payment transaction by the user via their user device 107. The account, actual repository of value (i.e., monetary value, other stored value device(s)) is stored 125 and maintained on an account system 105 that is in communication with the user device 107 (via the open data network 113) and the campus network 103 (via the closed data network). The campus network 103 receives the transaction request 119 from the user device 107, establishes network access to the account, and communicates with the unattended terminal 101 to enable further processing. In this respect, the campus network 103 forwards 131 the transaction request 119 to the account system 105. Upon receipt of the transaction request 119, the account system 105 matches the received Acct ID 139 with the user account information 125 and returns 133 a matched transaction request 119′ to the campus network 103 for forwarding 135 to the unattended terminal 101. Advantageously, the matched transaction request 119′ includes sufficient account information read from the user account information 125 to enable a payment transaction to be processed. Upon receipt of the matched transaction request 119′, the unattended terminal 101 executes its transaction functions as if it had received a transaction request through performance of a card swipe and follows the same transaction path as if a card had been used. Methods and apparatuses for processing transaction requests in response to a card swipe are known in the art and need not be described here in further detail. The user, after submitting the transaction request 119, can proceed with what they would do after swiping their card and make a selection of their desired item.

In some embodiments, communication amongst the various components of the mobile payment system 100 of the variously described embodiments, including without limitation, the campus network 103, unattended terminal 101, the user device 107, and the account system 105, can be enabled over web services, such as the Internet. The system communications capabilities can be established in any manner, utilize any web service and/or networking capability and can provide for the transmission of various digital data and information. The system can be an internet protocol (IP) network using one or more known protocols for data transports, including hypertext transfer protocol secure (HTTPS), datagram protocol (UDP), transport control protocol (TCP), and the like. The system and/or network can be established in .Net format that supports Simple Object Access Protocol (SOAP) requests. Communication can be further supported through a web service Application Program Interface (API) which supports Extensible Markup Language (XML), JavaScript Object Notation (JSON), JSON-like Separated Values (JSV), Comma Separated Values (CSV) and SOAP. The system and/or network can include a variety of networks, such as a local area network (LAN), wide area network (WAN), and the like. It is further contemplated that communication amongst components of the system can be created by instantiating a Wi-Fi connection or dial up connection over conventional telephone lines, for example, between the user device 107, campus network 103, unattended terminal 101, and/or account system 105.

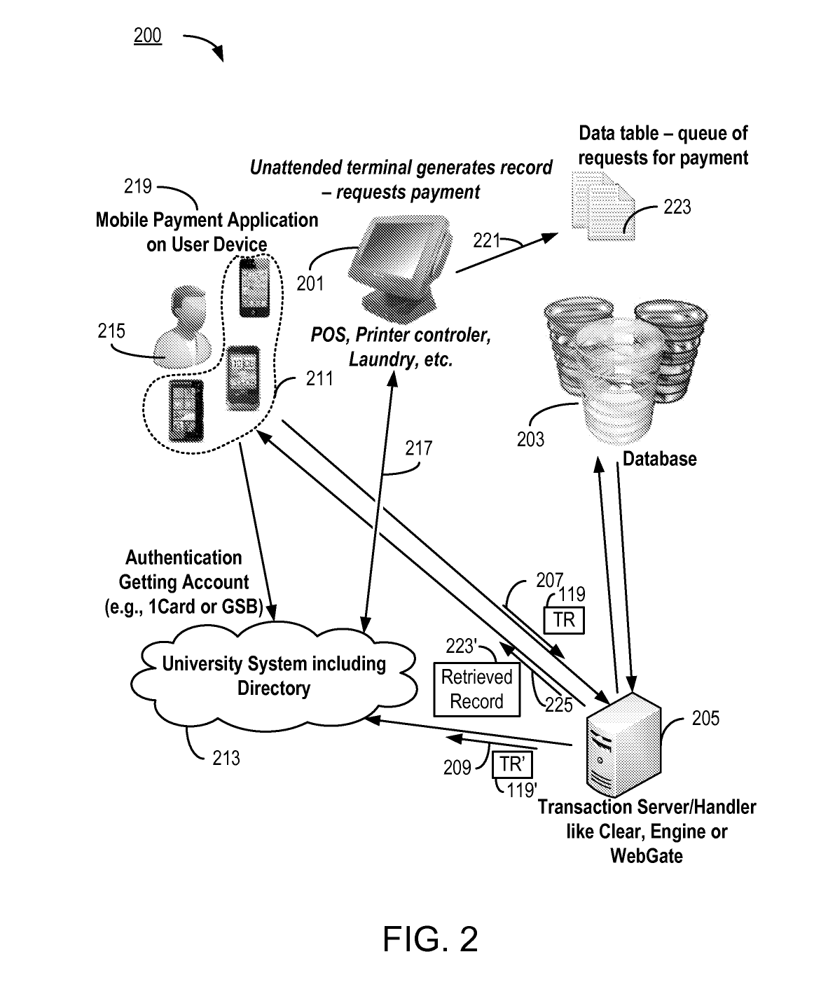

A delivery mechanism 117 in the form of a vending machine that can be a component of the mobile payment system 100 can be any machine, device, mechanism, and the like, which is enabled through its connection with an unattended terminal 101 to vend a product and/or service via a transaction request 119, 119′ transmitted from a user device (mobile payment enabled computing apparatus). Other mechanisms, as contemplated by those skilled in the field, for the execution of a mobile payment transaction and delivery of desired items to a user via transaction processing over the mobile payment system 100 can be employed. For instance, a POS terminal 201 (shown in FIG. 2, which is described in greater detail below) can provide similar transaction processing capabilities for a requested transaction submitted by a user via a user device 107 over the campus network 103 as that of a terminal 101 for a vending machine 117.

The unattended terminals 101 are electronic payment transaction terminals that do not necessarily have a person present to assist in the operation of the terminal and performance of a transaction (hence the term “unattended”). These terminals 101 can perform an electronic payment transaction without the use of a card or requiring a card swipe at the terminal 101. Thus, the terminals 101 receive and transmit necessary information for transaction processing through the network (campus network) 103 upon which they reside. These terminals 101 also perform their function and cause the delivery of a product and/or service from a delivery mechanism 117 to which it is operationally coupled 115 without additional input or assistance. For example, the performance of a mobile payment transaction and item delivery to a user, as described herein, can occur from a delivery mechanism (unattended vending machine) 117 that does not require interaction from a third party to provide the item to the user. The capability to perform these types of transactions in this manner by these terminals 101 is a functional association between the terminal 101 and the mobile payment application 109 loaded on the user device 107. The required functional capabilities for these terminals 101, that allow it to interact with the mobile payment enabled computing apparatus 107, can be provided through their firmware and/or through software application(s) 141 downloaded to the terminals 101. The terminals 101 can have the capability to perform card swipe reading (not shown) of magnetic strips presented to them via a card swipe. In embodiments consistent with the invention, the terminals 101 receive the necessary information from the transaction request 119′ derived from the transaction request 119 submitted via a user device 107 by the user and are able to process the transaction over the campus network 103 with the account system 105 as they would had a physical card been presented.

As indicated, the campus network 103 is a closed loop network which means that the terminals (unattended terminals) 101, and therefore all vending machines or other delivery mechanisms 117, reside upon the network. The campus network 103 can be thought of in terms of a network of communicating computing devices. The campus network 103 can be a network for a particular institution, such as a school, university, and/or college or a business, company, corporation, and the like. The campus network 103 contemplates networking computing devices found generally proximal to one another or in a localized geographic or physical location. Alternatively, the networked computing devices can be geographically remote from one another. The network establishes access control to the computing devices (i.e., unattended terminals) 101 associated with the institution. The network also enables the set-up, administration and performance of mobile payment transactions, as described herein, through and upon the various computing devices within the network.

The transactions performed by the mobile payment system 100 may be for various items, such as laundry products or services, meal-plans, photocopying, printing, dining, and other products and/or services that can be made available for transaction. The transaction may occur through or over various machines, devices, kiosks, stands, and the like. As described, the transactions are electronic payment transactions in which a user makes payment for an item via a user account 125. The form of payment made or value tendered can vary, wherein the accounts may hold value in the form of money, funds, currency or other indications of stored value.

The accounts are non-branded accounts which are hosted by a third party system (a.k.a., the “account system”) 105 which holds the available account funds or other indications of stored value. For example, the user account 125 can be a stored value account established in association with the campus network 103. The number of accounts and the amount of value (i.e., currency, other identifiers of value as may be contemplated) are stored and maintained by the account system 105. The accounts of the account system 105 are stored in one or more databases 203 (see FIG. 2) that can be communicated with by the campus network 103 and user device 107. This communication capability may be established directly or indirectly via an account system interface. The campus network 103 accesses or uses the non-branded accounts for payment processing of the transaction requests 119 submitted from user devices 107 loaded with the mobile payment application 109. Alternatively, it is contemplated that the campus network 103 hosts the accounts 125 used for payment processing of the transaction requests 119.

The indication of the user account 125 provided in the transaction request 119 is the account identifier 139. The account identifier 139 is a digital or virtualized representation of a single user account that has been registered to the user device 107 upon which the mobile payment application module 109 has been loaded. The account identifier 139 is stored in digital form upon the user computing device 107. The user account 125, stored on the account system 125, can be any form of a financial account (payment account) from which value, such as monetary value, can be accessed and provided for the purchase of an item by means of an electronic payment transaction. The user account 125, via the account system 105, is communicatively available over the Internet 113 and the campus network 103 can access the account 125 for the processing of an electronic payment in association with a transaction request119 by a user. It can be the case that the account identifier 139 associates or communicatively couples an account 125 directly through the campus network 103.

The account identifier 139 can include any information such as a personal account number (PAN), aliases, nicknames, user created designators, logos, symbols, and the like. The account identifier 139 enables the network to associate the user's transaction request 119 with the user account 125, thereby forming the matched transaction request 119′. Thus, it is contemplated that the account identifier 139 can be any virtualized representation of a user account, thereby enabling the network to access the user account 125 in order to process the requested electronic payment transaction. The account identifier 139 can include various other information or data, such as user contact information, phone number, email, and other information such as date of birth, spouse, spousal information, and the like. In some embodiments, the account identifier 139 could also include a social security number. However, inclusion of a social security number is not included because, in order to protect the user's identity, it is generally undesirable to store such information in a database, especially when it can be associated with user information such as name, address, birthdate, and the like.

It is contemplated that a web service API can be a transaction handler for the mobile payment system 100, interfacing components of the system such as the user device 107, account system 105, campus network 103 and unattended terminals 101. In one embodiment 200, schematically depicted in FIG. 2, a transaction server/handler 205 is provided that communicates a transaction request 119′ including an account identifier received 207 and matched from a user device 211 to a campus network 213 for processing transaction requests 119′. The transaction request 119′ is directed 209, via the transaction handler 205, to an unattended terminal 101, 201 that is operationally coupled 115 with a delivery mechanism 117 for providing a user a product and/or service.

A mobile payment system is based on a transaction handler 205 that receives 207 a transaction request 119, including an account identifier 139 connected to an account 125, from a mobile payment enabled computing apparatus 211 for processing the transaction request 119. The transaction request 119 is associated with an unattended terminal 101, 201 that is operationally coupled 115 with a delivery mechanism 117 for providing a user a product and/or service.

A mobile payment system is based on a transaction handler 205 that communicates 209 a transaction request 119′, including an account identifier connected to an account 125, received from a mobile payment enabled computing apparatus 107, 211 to a campus network 103, 213 for the processing of a transaction request 119′. The transaction request 119′ is associated with an unattended terminal 101, 201 that is operationally coupled 115 with a delivery mechanism 117 for providing a user a product and/or service. Based on the account status the transaction handler 205 processes the transaction request 119′ and can make payment on behalf of the user. The delivery mechanism 117 is communicatively linked to the transaction handler 205 by the unattended terminal 101, 201 that is operationally coupled 115 with the delivery mechanism 117, wherein the delivery of a product and/or service and the making of a payment on behalf of the user is based on a transaction authorization.

It is to be understood that the hosting, storage, and operational capabilities provided through the various components of the mobile payment system of the current invention can be provided by various computing devices. For instance, a server computer 205 can operate to provide a transaction server that communicatively connects the user device 211 with the campus network (such as a University Lightweight Directory Access Protocol (LDAP) System) 213 and the user account 125 stored in a database 203. It is contemplated that the transaction server 205 can be included in the account system 105 or operate as an intermediate server (account system interface). An intermediate server can provide a communication connection between one or more components of the mobile payment system 100, 200. For instance, an intermediate server 205 can provide the interface with the account system 105 and/or the campus network 103, 213. It can also provide operational capabilities as a transaction handler for the system. It is also contemplated that the campus network 103, 213 can utilize a server computer (directly or indirectly as an intermediate server) to provide communication to/from various components, such as the unattended terminals 101, 201, account system 105 and/or user device 107, 211. The campus network 103 may also provide access to other computing devices or storage means, such as a database or other memory.

The hardware and software specifications and capabilities of the server computer (a.k.a., campus network server, transaction server, intermediate server, interface, transaction handler) 205 employed by embodiments consistent with the invention can be standard to the industry or include such additional features and capabilities as may be contemplated for use by those skilled in this field. For instance, the server computer 205 can employ a server program (software application) such as Clear, Tr. Engine, WebGate, and the like.

In order to further illustrate aspects of embodiments consistent with the invention, FIG. 2 illustrates an exemplary process for performing a payment transaction in accordance with exemplary embodiments. In accordance with registration steps as described above, an account identifier 139 that is connected to an account 125 is stored on a user device 107 (step 301). Upon completion of registration, the user device 107 is ready to be used to carry out the mobile payment transaction process whenever the user is ready.

At some point in time subsequent to registration, the user decides to make a mobile payment transaction and so interacts with the user device's user interface 145 to initiate the process. This causes the user device 107 to transmit a transaction request 119 over a data network 113, 103 to one or more network components that reside on the network, the network components at least including an unattended terminal 101. The transaction request 119 includes the account identifier 139 and the terminal ID 125 (step 303).

One or more components that are resident on the network process the transaction request and deliver a transaction authorization to the unattended terminal (step 305). The transaction authorization instructs whether the unattended terminal can proceed with the transaction.

The user device is enabled as a mobile payment computing apparatus 107 for performing mobile electronic payment transactions over the campus network 103 by loading the user device 107 with a mobile payment software application (the “mobile app”) 109, which provides several capabilities to the user through the user device 107. The mobile app 109 can be loaded upon various computing devices and information handling systems. It is contemplated that the user device 107 can be a mobile phone 207 loaded with the mobile app 109 that operates in accordance with various inventive principles as described herein. Alternatively, the user device 107 may be any type of computing apparatus or information handling system, including without limitation smart phones, PDAs, tablets, personal computers, and the like.

The software download (mobile app or program) 109 generally includes instructions executable by a computing device 111, such as those identified above. The software download for establishing the mobile payment capabilities on a computing apparatus is a mobile application for iOS and Android platforms. The software application can be written in Objective C for iOS, and in Java™ for Android. It is contemplated that the mobile app 109 may be created using a variety of known programming languages, either alone or in combination, including without limitation C++, Visual Basic, Java Script, Pert, and the like.

The mobile app 109 enables the user to register their user account in the mobile device. Registration of the account to the user device includes an authentication process, whereby the association of a user account 105 with the user device 107 is validated to help ensure that access to the account 105 is proper. The application can accomplish this authentication through direct connection with the campus network or, as illustrated in FIG. 1, indirectly 143 through an intermediate server. The intermediate server can be a transaction server 205 (shown in FIG. 2). The mobile app 109 enables the user to submit transaction requests 119 to the closed loop system for processing using their mobile device 107. In operation, the mobile app 109 enables the user to process a transaction to an unattended device by sending a transaction request 119, via a network 103, to an unattended terminal 101 operationally coupled with the unattended device 117.

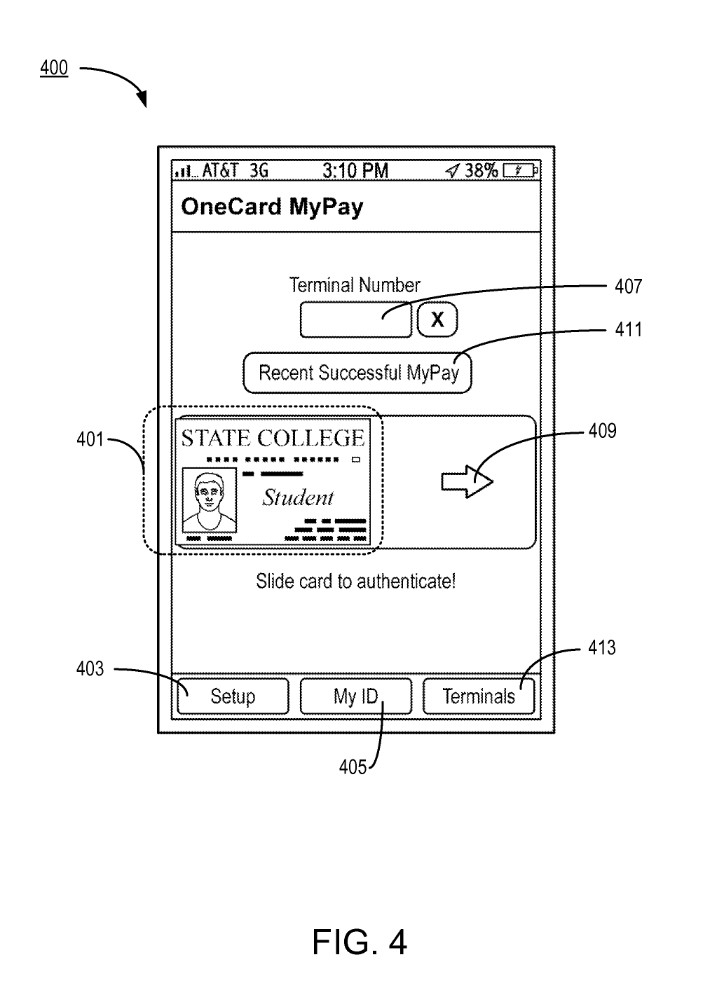

FIG. 4 is a screenshot 400 of an exemplary graphical user interface (GUI) presented on a user interface 145 of the user device 107. As shown in this exemplary embodiment, the mobile app 109 can provide a user with a virtual identification (ID) card 401 upon and through their user device 107. Upon account registration 143 in the user device 107 (herein described) the mobile app 109 can check the network, in particular the database(s) 203 that serve the mobile payment network, to identify information for creation of the virtual ID card 401. Information identified can include ID card formatting, graphics, photo, and other information that may or must appear on a physical ID card if printed from an ID card printer. Using this information the mobile app 109 can create a virtual ID card 401 for display upon and use through the user device 107.

The mobile app can also present a list of terminals 101 that have been used recently. This can be a list of terminals through which the user (account holder) has recently used the module to process transactions. This can increase the ease of identifying and selecting of a terminal that a user has processed through recently. This may increase the ease of using the mobile app 109 for transaction processing by the user.

User devices 107, network servers, transaction servers 205, intermediate servers, unattended terminals 101, 201, transaction handlers 205, and other computing apparatus can employ various computer operating systems based upon various different system platforms, including without limitation, Microsoft Windows® based operating systems, Unix based operating systems, and the like, as known to those skilled in the field. The computing apparatus employed may include handheld computers, laptops, notebooks, desktops, point of sale terminals, servers, mainframes, and other computing devices known to those skilled in the field. In general, the automated execution of instructions to perform one or more processes is provided by a software application, such as the mobile app 109, and is handled by a processor (e.g., processor 111) receiving the instructions from a memory, a computer readable medium, and the like (generally depicted and hereinafter referred to as “memory 145”), and then performing one or more of the processes. Processes performed may include processes similar to those described herein for the embodiments consistent with the invention.

The memory or computer readable medium where instructions are stored and from which instructions may be received can be any medium that provides data readable by a computing device. This can include random access memory (RAM), dynamic random access memory (DRAM), any other memory chip, such as a PROM, EPROM, FLASH-EEPROM, or CD-ROM, DVD, any other optical medium, or hard disk, flexible disk, any other magnetic medium.

Databases or data stores 203, such as those shown in FIG. 2, can include various mechanisms for storing, accessing, and retrieving various kinds of data. The various mechanisms may include without limitation an application database in a proprietary format, a set of files in a file system, a hierarchical database, a relational database management system, and the like. Each such database or data store is generally included within a computing device employing a computer operating system such as those described herein and is accessed via communication over the system in any one or more of a variety of manners as described herein.

A mobile payment transaction may be accomplished by using a system that operates in accordance with the invention in many different ways. For example, a user may download the mobile payment application (software application herein referred to as the “mobile app”) 109 on their user device (e.g., mobile phone) 107. When the application 109 is downloaded the user can login and register 143 their user account 125 in the user device 107. This registration 143 includes the user device 107 connecting to the account system 105 and the account system 105, in response, recording an identification of the user device 107, such as a User Device ID (UDID) or the like of a phone, and that user account 105 is registered in the application. This promotes security by attempting to ensure the user account 125, and therefore access to the user account, can only be provided or tied to one user device 107 at a time.

A “Setup” button 403 in the GUI, shown in FIG. 4, can enable a user to access a functional module of the mobile app 109 that allows them to perform various tasks. For instance, via selection of the “Setup” button, the user may be presented with the ability to login and register their user account in their device. It is contemplated that the presentation of the login and registration functionality may be at least partially automated. For instance, upon download of the application 109 a user may be immediately directed to perform the task of registering 143 the account with the user device 107. Alternatively, the user may be required to manually select the “Setup” button to proceed with login and registration. Various other administrative and/or user directed capabilities may be enabled through the “Setup” functional module of the mobile app 109 as are known and contemplated by those ordinarily skilled in this field. For instance, the user may be enabled to change the display presented on their user device 107, select a particular network, change communication means, update the mobile app 109, and the like. Updating of the mobile app 109 can occur via communication with the campus network 103 or a third party network directly or indirectly as is known in the field.

Where enabled through the network and the user wants a virtual ID card 403 on their device 107, the application 109 can collect needed information (ID information) from the network and virtualize an ID card 403 (FIG. 4) for display on the user device 107. This can include showing the user how the physical ID card looks when printed as a card, complete with their photo, card design and text that would normally appear on the physical ID card. The user can be presented a “MyID” button 405, displayed upon their user device 107, for selection. A user may select this option and be presented with the ability to enter and/or retrieve data and information for entry, into the virtual ID functional module of the mobile app 109, that is relevant to establishing and displaying a virtualized user ID 403 upon their device 107.

When the user is ready to make a purchase to an unattended device, such as a vending machine 117, the user can select the unattended device 117 in various ways. This selection occurs through the identification and transmission of a terminal ID to the mobile payment network as part of a transaction request 119.

For example, the user can directly enter the terminal ID into the application on their device. The user may be presented with a display box or data entry box 407, such as shown in FIG. 4, into which data entry, such as a terminal ID number, may be entered. The display may include various instructions, such as “Enter Terminal #”, on the screen to assist the user in entering the terminal number directly into the application on their device for transmission from the user device as part of the terminal ID.

The user can get the terminal number from its appearance on the display screen of the terminal 101 or from an indicator (sign, display, sticker, and the like) placed at the vending device 117 with its terminal ID. It is understood that a terminal ID is associated with a single device, such as a vending device or POS device. In exemplary operation, when a user enters the terminal ID and slides 409 their virtual ID 401 across the display screen of the user device 107, in accordance with the embodiment shown in FIG. 4, the user device 107 sends the terminal ID to the campus network 103.

Alternatively a user can identify for submission as part of a transaction request 119 the terminal ID from a text list of terminal ID numbers that can be displayed upon the user device and/or from a list of most recently used terminals (a “favorites list”) that can be displayed upon the user device 107. The mobile app 109 can display a “Recent Successful MyPay” button 411, as shown in FIG. 4, for selection by a user. When a user presses this button 411 they can be shown a listing of various terminal ID numbers. The terminal ID numbers shown are associated with that user due to recent transaction requests 119 submitted by the user for those terminal ID numbers. It can be the case that the listing of terminal ID numbers displayed to the user include the terminal ID number for which the user desires to submit a transaction request 119 to the network.

In addition, the user can be presented a visual reference, such as a map (“terminal map”) which will show where they are and the devices 117 around them that can accept a transaction request 119 from the user device 107 enabled with the mobile payment application 109. Selection of an unattended terminal 101 from such a map is enabled by the mobile app 109 using global positioning system (GPS) circuitry within the user device 107. All devices within the network can have the ability to be configured with the GPS latitude and longitude location of the reader or terminal so that they appear on a map for the user or account holder. Then the user can select the terminal when submitting a transaction request 119. This may also provide a user with information regarding the nearest terminals and the devices they serve. From this a user can identify available products and/or services and their geographic relationship to the user's current position.

The “Terminals” button 413 displayed on the screen of the user device, as shown in FIG. 4, allows a user to access the terminal map. Other buttons or methods of accessing this capability may be provided to a user. Terminals that are communicatively linked over the mobile payment network established by the current invention can be defined with GPS latitude and longitude so that they appear on the terminal map. This functionality may provide a display of terminal ID numbers or provide access to additional information, such as the terminal ID number, associated with a particular terminal identified on the map.

In another aspect of some embodiments, the list of terminals or their depiction on a map can be the output of a filtering process performed by the mobile app 109. In accordance with this aspect, the user specifies one or more types of filtering to be performed (e.g., by distance from the user's present location, by machine category (food, beverages, newspapers, printers, copiers, . . . )), and only those unattended terminals 115 satisfying the search criteria are included in the displayed list and/or map.

In another aspect of some embodiments, the mobile app 109 works in conjunction with the user device's camera-related components to enable a user to select an unattended terminal 101 optically by using the user device 107 to scan and thereby select a Quick Response Code (QR Code®) that contains the terminal information required for transaction processing. This will allow the user to then transmit the optically obtained terminal ID in making a transaction request 119. The QR Code® can be placed at the terminal 101 or delivery mechanism 117 itself or displayed by the terminal for scanning. The QR Code® can contain terminal ID number, device ID number, name and location, but may also include other information. This may increase the ease and efficiency by which a user can submit a transaction request 119 from their user device 107 to the network 103.

Once the user selects the unattended terminal 101, by entering the terminal ID into the user device 107 as, for example, shown in FIG. 4, for which they wish to make a transaction request they simply send the information to the network 103. The user may be presented several options as to how they can send the information, for instance they can be enabled to press a “Swipe” button, slide their fingers across the screen 409 or perform such other act as directed by the capabilities provided through the mobile payment application 109. In an exemplary embodiment, such as that shown in FIG. 4, where a user has a virtual ID card 401 presented through or displayed upon their user device 107, the user may slide their finger across the screen on the virtualized ID card 401.

Once the user has sent the information by pressing, swiping or performing some other affirmative act, the application 109 sends the transaction request 119 over the web service (e.g., Internet) to the campus network 103, unattended terminal and account system. The unattended terminal 101 executes its transaction functions as if it had received a transaction request through performance of a card swipe at the unattended device 117 to which it is operationally coupled 115 and follows the same transaction path as if a card had been used. The user interacts with the delivery mechanism 117 in the same manner that they would after swiping their card and selects their product or service to be received.

A dining environment may use the mobile payment system(s) of the current invention. The transaction flow in this environment can be somewhat different than in other environments, such as the unattended terminals coupled with vending machines. For instance, in a dining environment a user typically develops an “order” comprising one or more user selected items that they wish to purchase in a single transaction. In this environment the transaction is often handled by personal computer (PC) based terminals or POS dining terminals. The transaction request 119, including account identifier, is sent from the PC to the network. For that PC the network establishes an order queue (or table) which holds the ordered items in a queue that the PC program (print release station or dining POS) will look at once a payment method is selected. The payment methods that are made available for selection are consistent with those methods that are enabled over the network. The waiting account transaction is selected with account information and photo displayed to process the transaction and seek an authorization.

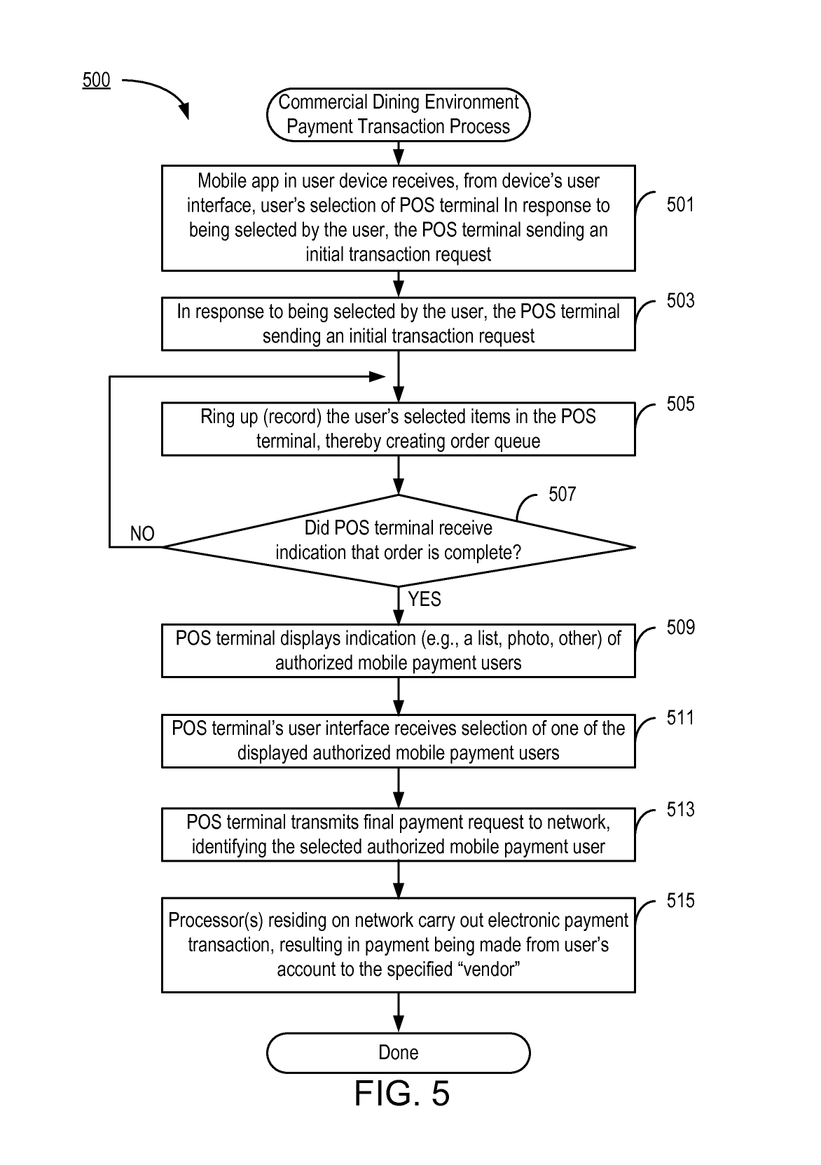

To facilitate a further understanding of aspects of the mobile payment system in the context of a commercial dining environment, these and other aspects are illustrated in FIG. 5, which is, in one respect, a flow chart of steps/processes performed by circuitry in accordance with some but not necessarily all exemplary embodiments of the invention. In another respect, FIG. 5 can be considered to depict exemplary means 500 comprising the various illustrated circuitry (e.g., hard-wired and/or suitably programmed processor) configured to perform the described functions.

In the dining environment, the user at any time may select the POS dining terminal located in a dining facility within which the user wishes to perform a transaction. For example, the POS dining terminal may be selected by the user prior to, during or after the user has completed the selection of the items they wish to purchase (step 501). It is contemplated that the POS terminal can be established with a touch-screen display and other industry standard capabilities. At any time, the user who has a mobile payment application 109 loaded upon their user device 107 can select the dining POS at the dining location through their user device.

In the dining environment, when the dining POS is initially selected by the user it “sends” an initial transaction request (step 503). The “sending” of the initial transaction request can communicate to the terminal and campus network that the user intends to submit a transaction request through this terminal using their mobile payment application 109 on their device 107. The initial transaction request may occur prior to the selection of any items by the user, while the user is in the process of selecting their items or after they have selected the items they wish to purchase through the dining POS terminal. It is contemplated that the initial transaction request may include no indication of any user selected items or may include an indication of user selected items.

As the user selects their items or after they have completed selecting their items, a cashier can enter or ring-up the selected item(s) on the POS dining terminal. In other embodiments, the user can enter or ring-up their selected item(s) on the POS dining terminal (step 505). Ringing-up of the selected item(s) allows for the calculation of the total amount (monetary value) due in payment for the selected items. To accomplish the calculation of the amount due, an order queue of the selected item(s) is created. The queue tracks and builds a list of the selected items. This queue is interactive allowing for the addition and/or deletion of items from the list until the order is completed. The completion of the order is a user determined event and occurs when the user indicates that there are no other items they wish to have included and pay for. Accordingly, the POS terminal continues to allow the user to enter and delete items for so long as it does not receive an indication that the order is complete (“NO” path out of decision block 507).

In order to submit a final payment request the appropriate designator on the POS dining terminal must first be selected. This designator may be a key, button and/or on-screen display of the POS dining terminal that is capable of being selected by a cashier or user. The selection of the mobile payment designator (“YES” path out of decision block 507) causes the POS dining terminal to provide a display of authorized mobile payment users (step 509). Authorized mobile payment users are those users who have properly registered their user device with their user account on the campus network. The display can be a listing of the names authorized users. The display may include an indication of a user, that indication can include a photo or other visual representation of the user and may also include additional information.

The user requesting the transaction must be matched with one of the authorized users being displayed on the POS dining terminal. In operation, the display of the authorized users on the POS dining terminal can allow the selection of the one authorized user that matches the requesting user. The display of authorized users can include an on-screen selection capability by “pressing” the screen in a location proximal to the displayed representation of the authorized user that matches the requesting user. The display of authorized users can be scrolled through and a selection can be made by pressing a button or key on a mouse, keypad or other data entry mechanism operational with the POS dining terminal (step 511). This matching of the requesting user with an authorized user may be accomplished by a cashier, the user or a third party.

The final payment request is transmitted to the network after the matching of the requesting and authorized user has occurred (step 513). It is understood that this request can result in the standard processing of an electronic payment transaction as is contemplated for the completion of the purchase of the selected items by the customer. In completing the purchase, a payment can be made from the user account to the specified “vendor” (step 515). In accordance with exemplary embodiments consistent with the invention, the vendor in this instance is a campus account, associated with the unattended terminal, residing on the campus network. Thus, the campus network 103 via the account system 105 can request and receive payment for a purchase made by a user.

In order to further illustrate aspects of inventive embodiments in the context of a dining environment enabled with the mobile payment capabilities, in the following is presented with reference to FIG. 2. In this example, a mobile payment transaction is performed in a dining environment by a student 215 using the mobile payment capabilities of the student's mobile phone 211 as provided by embodiments that are consistent with the invention. The student 215 approaches an unattended terminal 201 residing upon (217) the campus network 213. The unattended terminal 201 is operationally coupled to a means of delivering a product and/or service to the student. The campus network 213 is a University System upon which the terminals reside and that contains a directory of students. The unattended terminal 201 can be a POS device, printer controller, laundry device, and the like as indicated previously. The student 215 has loaded their mobile phone 211 with the mobile payment application 219 that is configured in accordance with embodiments consistent with the invention and has registered their account on their phone 211. Using the mobile app 219 on their phone 211, the student submits 207 a transaction request 119, including their account identifier and the terminal ID, to authenticate their account against the campus network 213. The authentication process can occur within one to three seconds from submission or another time period that supports the real-time or near real-time nature of the transaction capabilities provided by the mobile payment application 219.

After authentication the unattended terminal 201 offers the product and/or service for sale and the amount due is displayed to the student 215. Then for example on a POS terminal (i.e., POS dining terminal and the like), the student or cashier can press a button and the record is written 221 in the table 223 of the database 203, which is a queue of recorded waiting payments. Recording into the table for waiting payments can occur within one to two seconds from submission or another time period that supports the real-time or near real-time nature of the transaction capabilities provided by the mobile payment application. The record 223 can include student ID (account identifier), terminal ID, the purchase amount and a timestamp. The record may include various other data and information as previously identified.

When the student 215 is finished selecting their items for purchase they access their mobile payment enabled phone 211, which is enabled to provide the student the ability to identify the terminal 201, and transmit a terminal identification to the payment system. The application can provide the user an ability to identify the terminal in several different formats, including without limitation, a dialog field or interactive picture with the terminals. The student 215 may be enabled to browse and select terminals by room, section, or listing of terminals on the application.

Once the student 215 has identified and selected the terminal 201, the application enables them to submit 207 a transaction request 119 to the mobile payment system 207. This request queries for the records 223 waiting for payment from the particular terminal 201. The server program, executing on the transaction server 205, retrieves the record 223′ waiting for payment and sends 225 it back to the student's phone 211. The application allows the student 215 to see the total purchase amount for their selected items. The application 219 presents the student 215 with an ability to “confirm” the amount due for their selected items. This confirmation is accomplished by the student pressing a button, key or other data entry means that acknowledges the student's desire to proceed with payment for their transaction. The transaction server 205 makes the transaction and marks the record 223 for payment as “paid”. It is approximated to take two to three seconds from the time of student confirmation until the result of the transaction from the transaction server. The terminal 201 checks the record 223 and if it is “paid” it allows the items to be sold and the terminal 201 clears the record 223 into the table with waiting payments. The transaction server 205 provides the confirmation for the successful (or unsuccessful) transaction to the student's phone (not shown for the sake of avoiding cluttering the figure).

It is contemplated that the delivery of the product and/or service requested, in all system and method embodiments consistent with the invention can be based on the status of the account, wherein if sufficient value (i.e., funds) are available for withdrawal from the account to purchase the requested items then the transaction can be completed. However, where insufficient value is found in the account then the purchase is denied or the transaction is not authorized. A transaction authorization delivered by the network to the unattended terminal instructs whether to perform the requested transaction or not. It is contemplated that payment, from the user account, is tendered to an account associated with the networked, unattended terminal. The account associated with the networked, unattended terminal can be a campus account that resides upon a campus network. Alternatively, the account associated with the networked, unattended terminal can be a third party account that resides on a third party system or network.

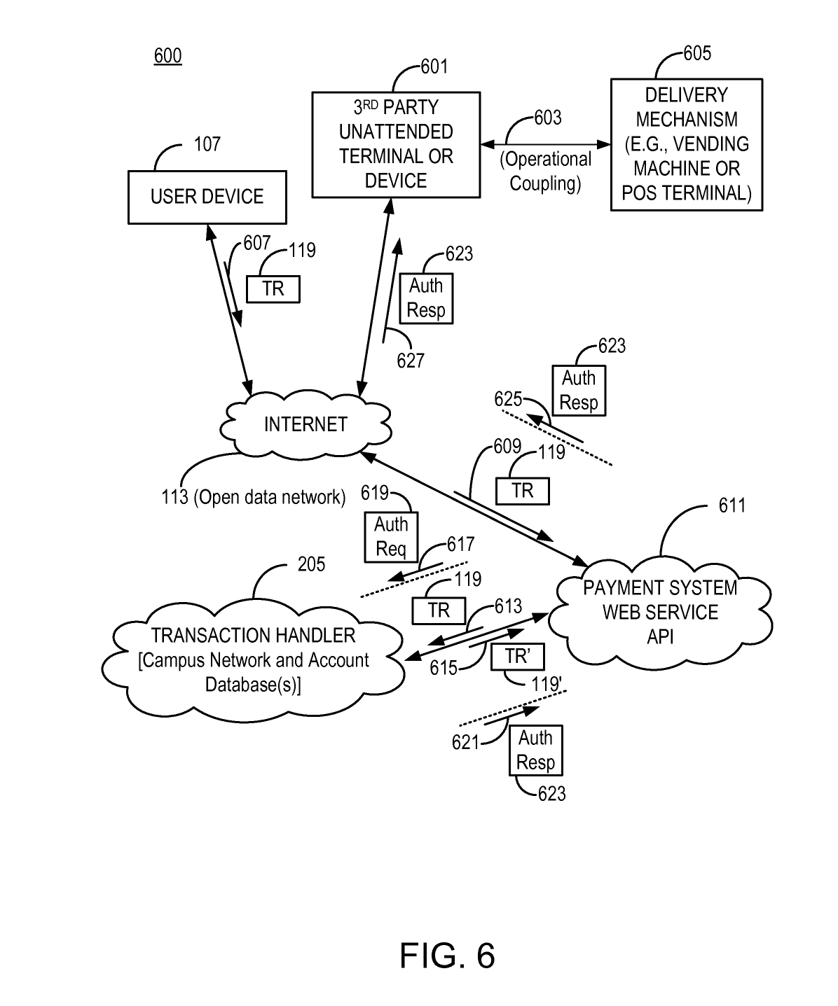

As mentioned earlier, in some embodiments, communication amongst the various components of the mobile payment system 100 of the variously described embodiments, including without limitation, the campus network 103, unattended terminal 101, the user device 107, and the account system 105, can be enabled over web services, such as the Internet. FIG. 6 is a schematic diagram of one such exemplary arrangement 600 that enables the mobile payment system to effect mobile payments directed to third party unattended terminals or devices, by which is meant unattended terminals or devices that are not directly coupled to the campus's closed network.

In the exemplary mobile payment system 600, a third party unattended terminal 601 is operationally coupled 603 to a delivery mechanism 605. When it is desired to make a payment toward the third party unattended terminal 601 the user device 107, controlled by its mobile app 109, sends 607 a transaction request 119 through an open data network 113, such as the Internet, to 609 a payment system web service API 611. In this instance, the transaction request 119 includes the user's account ID and the terminal ID of the third party unattended terminal 601.

Upon receipt of the transaction request 119, the payment system web service API 611 recognizes the terminal ID as being associated with a third party unattended terminal 601 rather than one sitting on the closed campus network. Accordingly, it acts as a proxy for the third party unattended terminal 601 on the closed network. Accordingly, it interacts with the transaction handler 205, first forwarding 613 the transaction request 119 to the transaction handler 205, receiving in response 615 a matched transaction request 119′, then sending 617 an authorization request 619, and receiving in response 621 an authorization response 623. The payment system web service API 611 then forwards 625, 627 the authorization response 623 to the third party unattended terminal or device 601. If the authorization response 623 indicates that payment has been authorized, then the third party unattended terminal or device, via its operational coupling 603, enables the delivery mechanism 605 to function as though a physical payment card had been swiped, as earlier described.

It will therefore be understood from the above that the payment system web service API 611 (which resides on a campus-based Web server) is, on the one hand, used by the mobile app 109 for the transaction request towards the third part unattended terminal 601 and, on the other hand, is used by the third party unattended terminal 601 to gather the transaction authentication request for itself registered into the account database. The third party unattended terminal 601 then proceeds with the financial transaction again through the payment system web service API 611 to debit the cardholder balance by an amount required for the product/service delivery, with payment being made to the vendor.

A mobile payment system is based on a user device that stores and transmits to a campus network an account identifier that provides information for processing transaction requests and the delivery of products and/or services from a delivery mechanism. The campus network is in communication with the delivery mechanism via an unattended terminal.

A mobile payment system is based on a transaction handler of a campus network enabled to receive a transaction request from a user device, wherein the user device stores and transmits an account identifier connected to a user account, to the transaction handler. The campus network processes the transaction request to a networked unattended terminal operationally coupled with a delivery mechanism. The delivery of a product and/or service from the delivery mechanism is based on a transaction authorization.

A mobile payment system is based on an account identifier, connected with an account, which is stored upon and transmitted from a user device to a campus network in connection with a transaction request for the delivery of a product and/or service from an unattended terminal.

A mobile payment system is based on a campus network receiving a transaction request, including an account identifier connected to an account, the account identifier stored and transmitted from a user device to the campus network in making the transaction request. The transaction request is associated with a campus networked unattended terminal that is operationally coupled with a delivery mechanism for providing a user a product and/or service.

In an embodiment consistent with the invention, a method of performing an electronic payment transaction via a networked, unattended terminal over a closed network is provided. The method comprises storing, on a computing apparatus, an account identifier connected to an account hosted on an account system. The computing apparatus transmits a transaction request, including the account identifier, to an unattended terminal operationally coupled to a vending device. The transaction request is for a sale to be made that, if authorized, results in the delivery of a product and/or service from the vending device to a user who submitted the purchase request. A campus network transmits a transaction authorization to the unattended terminal instructing whether to proceed with the sale or not.

In an embodiment, a method comprises receiving a transaction request, for a sale from a vending device, by an unattended terminal operationally coupled with the vending device. The transaction request includes an account identifier, connected to an account, transmitted from a user device over a campus network to the unattended terminal. A transaction authorization is transmitted to the unattended terminal instructing whether to proceed with the sale or not.

In an embodiment, a method comprises processing a transaction request for a sale from a vending device by a campus network. A transaction authorization is delivered to an unattended terminal hosted by the network and operationally coupled with the vending device for determining whether or not to proceed with the sale. In this embodiment, the network receives an account identifier, stored on and transmitted from a user's computing apparatus, connected to an account in order to process the transaction request.

In an embodiment, a method comprises receiving a transaction request for a sale from a vending device, the transaction request including an account identifier connected to an account hosted on an account system, by a transaction handler of a campus network. The transaction request is communicated to an unattended terminal operationally coupled to the vending device. The transaction handler delivers a transaction authorization instructing the vending device whether to proceed with the sale or not.

The methods can include loading a mobile payment application upon a computing apparatus. The mobile payment enabled computing apparatus allows a user to present the transaction request, including the account identifier and a terminal identifier which identifies the unattended terminal, to the network. The methods can include transmitting a transaction authorization status for the requested transaction to the unattended terminal.

The methods can include the selection of an item (product and/or service) by a user, the item being associated with the unattended terminal communicatively coupled with the network. The item selection occurring prior to, in accordance with or after the transmission of the transaction request by the mobile payment enabled computing apparatus to the network. Based on the processing of the transaction request an authorization status for the vending event is delivered via the unattended terminal to the vending device.

The method can include all processing necessary for the completion of the requested electronic payment transaction. This can include item selection, order building by the selection of multiple items, submission of a total purchase amount for payment from the account, remitting payment from the account, receiving payment to an account, and other processing steps as contemplated by those of skill in this field.

### ADDITIONAL ASPECTS

The description and drawings are illustrative, non-limiting and give numerous specific details to provide a thorough understanding of the current invention. To enhance clarity of understanding, well known or conventional details, in certain circumstances, are not described.

Reference(s) to or the appearance of the phrase “one embodiment” or “an embodiment” means at least one and that they are not necessarily all referring to the same embodiment nor that separate or alternative embodiments must be mutually exclusive of other embodiments. It does mean that a particular feature, structure, or characteristic described in connection with the embodiment is included in at least one embodiment but not necessarily included in all. Similarly, various requirements are described which may be requirements for one embodiment but not other embodiments. Unless excluded by explicit description and/or apparent incompatibility, any combination of various features described in this description is also included herein.

Any disclosure of patent documents provided is hereby incorporated by reference. Use of headings is intended to ease reference and must not be interpreted as limiting any disclosure provided.

It is understood that the description of the processes, systems, methods and capabilities of the current invention have been set forth in a particular order or ordered sequence, but that such could be practiced in various alternative order or sequence to that herein described. Further, the capabilities executed (steps taken) and results provided may be performed simultaneously, other capabilities could be added, or that certain capabilities could be omitted.

Accordingly, the specific embodiments illustrated in the specification and drawings should not be regarded in a restrictive sense, but instead as exemplary. Further, various modifications may be made to these exemplary embodiments and equivalents substituted therefor without departing from the broader scope and spirit of the current invention as recognized by those of ordinary skill in the field. Accordingly, the described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of vending a product and/or service, the method comprising:
a user device transmitting, via a first data network, a transaction request that includes a terminal identifier and a user account identifier, wherein the user account identifier uniquely identifies a user account in a payment system;
a component coupled to the first data network and to a second data network receiving the transaction request and using the terminal identifier to direct transaction request information to an unattended terminal coupled to the second network, wherein the transaction request information is derived from the transaction request and includes information identifying the user account;
the unattended terminal receiving the transaction request information from the second data network;
the unattended terminal sending a payment authorization request to the payment system, wherein the payment authorization request includes the information identifying the user account;
the unattended terminal receiving a payment authorization response to the payment authorization request; and
the unattended terminal acting in accordance with information included in the authorization response, including enabling a product and/or service to be vended in response to the authorization response information indicating that a payment has been authorized by the payment system.

2. The method of claim 1, wherein the first data network is an open data network and the second data network is a closed data network.

3. The method of claim 1, wherein:
the unattended terminal is operatively coupled to a vending machine; and
enabling the product and/or service to be vended comprises the unattended terminal sending vending control signals to the vending machine, wherein the vending control signals enable the vending machine to vend the product and/or service.

4. The method of claim 1, wherein the unattended terminal sending the payment authorization request to the payment system comprises:
the unattended terminal executing one or more transaction functions that are performed in response to receiving, as a result of a card swiping, information stored on a physical card.

5. The method of claim 1,
wherein the unattended terminal is a point of sale terminal;
wherein the point of sale terminal sending the payment authorization request to the payment system comprises:
displaying a list of authorized mobile payment users;
receiving, through a point of sale terminal user interface, a selection of one of the displayed authorized mobile payment users; and
transmitting the payment authorization request to the payment system; and
wherein the method comprises:
the point of sale terminal sending an initial transaction request to the payment system that informs the payment system that a user of the user device intends to submit a transaction request through the point of sale terminal;
the point of sale terminal offering item selections to the user via a point of sale terminal interface;
the point of sale terminal receiving item selections via the point of sale terminal interface;
the point of sale terminal causing a queue of waiting payments to be created and stored in a database of the payment system;
the point of sale terminal causing the payment system to process the queue of waiting payments and to send the processed queue of waiting payments to the user device;
the user device receiving input from the user that indicates acceptance of the processed queue of waiting payments, and consequently sending a confirmation message to the payment system;
the payment system debiting the user account and crediting a vendor account based on the processed queue of waiting payments; and
the payment system confirming to the point of sale terminal that the queue waiting payments has been paid.

6. The method of claim 1, comprising:
the user device receiving, on a user device input interface, information representative of the terminal identifier.

7. The method of claim 1, comprising:
the user device presenting, on a user device output interface, a list of unattended terminals; and
the user device receiving, on a user device input interface, a user selection from the list of terminals, wherein the user selection indicates the terminal identifier,
wherein the list of unattended terminals is a list of unattended terminals that have been recently used by a user of the user device.

8. The method of claim 1, comprising:
using geographic positioning circuitry to identify a geographic position of the user device;
the user device displaying on a user device output interface a map that includes the geographic position of the user device; and
the user device presenting, on the user device output interface a graphic depiction of unattended terminals at positions on the map that correspond to respective geographic positions of the respective unattended terminals.

9. The method of claim 1, comprising:
the user device optically receiving an image of a QR Code®, wherein the QR Code® is displayed at a physical location proximate to the unattended terminal and/or at a physical location proximate to a vending machine that is operatively coupled to the unattended terminal.

10. The method of claim 1, comprising:
the user device receiving, from the payment system, information about a user of the user device;
the user device creating, from the received information about the user of the user device, a virtual identification card; and
the user device displaying the virtual identification card on an output interface of the user device.

11. The method of claim 1, comprising:
the user device presenting on a user device output interface, an image representing a readiness of the user device to initiate a mobile payment transaction;
the user device receiving data on a user device input interface and, by processing the received data, detecting that a user of the user device has performed a swiping motion on the user device input interface,
wherein the user device transmitting the transaction request is initiated in response to the user device detecting that the user of the user device has performed the swiping motion on the user device input interface.

12. An apparatus for vending a product and/or service, the apparatus comprising:
a user device configured to transmit, via a first data network, a transaction request that includes a terminal identifier and a user account identifier, wherein the user account identifier uniquely identifies a user account in a payment system;
a component coupled to the first data network and to a second data network, wherein the component is configured to receive the transaction request and to use the terminal identifier to direct transaction request information to an unattended terminal coupled to the second network, wherein the transaction request information is derived from the transaction request and includes information identifying the user account;
the unattended terminal, wherein:
the unattended terminal is configured to receive the transaction request information from the second data network;
the unattended terminal is configured to send a payment authorization request to the payment system, wherein the payment authorization request includes the information identifying the user account;
the unattended terminal is configured to receive a payment authorization response to the payment authorization request; and
the unattended terminal is configured to act in accordance with information included in the authorization response, including enabling a product and/or service to be vended in response to the authorization response information indicating that a payment has been authorized by the payment system.

13. The apparatus of claim 12, wherein:
the unattended terminal is operatively coupled to a vending machine; and
the unattended terminal being configured to enable the product and/or service to be vended comprises the unattended terminal being configured to send vending control signals to the vending machine, wherein the vending control signals enable the vending machine to vend the product and/or service.

14. The apparatus of claim 12, wherein the unattended terminal being configured to send the payment authorization request to the payment system comprises:
the unattended terminal being configured to execute one or more transaction functions that are performed in response to receiving, as a result of a card swiping, information stored on a physical card.

15. The apparatus of claim 12,
wherein the unattended terminal is a point of sale terminal;
wherein the point of sale terminal being configured to send the payment authorization request to the payment system comprises:
the point of sale terminal being configured to display a list of authorized mobile payment users;
the point of sale terminal being configured to receive, through a point of sale terminal user interface, a selection of one of the displayed authorized mobile payment users; and
the point of sale terminal being configured to transmit the payment authorization request to the payment system; and
wherein:
the point of sale terminal is configured to send an initial transaction request to the payment system that informs the payment system that a user of the user device intends to submit a transaction request through the point of sale terminal;
the point of sale terminal is configured to offer item selections to the user via a point of sale terminal interface;
the point of sale terminal is configured to receive item selections via the point of sale terminal interface;
the point of sale terminal is configured to cause a queue of waiting payments to be created and stored in a database of the payment system;
the point of sale terminal is configured to cause the payment system to process the queue of waiting payments and to send the processed queue of waiting payments to the user device;
the user device is configured to receive input from the user that indicates acceptance of the processed queue of waiting payments, and consequently sending a confirmation message to the payment system;
the payment system is configured to debit the user account and to credit a vendor account based on the processed queue of waiting payments; and
the payment system is configured to confirm to the point of sale terminal that the queue waiting payments has been paid.

16. The apparatus of claim 12, comprising:
the user device being configured to receive, on a user device input interface, information representative of the terminal identifier.

17. The apparatus of claim 12, comprising:
the user device being configured to present, on a user device output interface, a list of unattended terminals; and
the user device being configured to receive, on a user device input interface, a user selection from the list of terminals, wherein the user selection indicates the terminal identifier,
wherein the list of unattended terminals is a list of unattended terminals that have been recently used by a user of the user device.

18. The apparatus of claim 12, comprising:
geographic positioning circuitry configured to identify a geographic position of the user device;
the user device being configured to display on a user device output interface a map that includes the geographic position of the user device; and
the user device being configured to present, on the user device output interface a graphic depiction of unattended terminals at positions on the map that correspond to respective geographic positions of the respective unattended terminals.

19. The apparatus of claim 12, comprising:
the user device being configured to present on a user device output interface, an image representing a readiness of the user device to initiate a mobile payment transaction;
the user device being configured to receive data on a user device input interface and, by processing the received data, to detect that a user of the user device has performed a swiping motion on the user device input interface,
wherein the user device is configured to initiate transmission of the transaction request in response to the user device detecting that the user of the user device has performed the swiping motion on the user device input interface.

20. A non-transitory computer readable medium having stored thereon a set of program instructions that, when executed by one or more processors, cause the one or more processors to perform a method of vending a product and/or service, the method comprising:
a component coupled to a first data network and to a second data network receiving, from the first data network, a transaction request that includes a terminal identifier and a user account identifier, wherein the user account identifier uniquely identifies a user account in a payment system;
the component using the terminal identifier to direct transaction request information to an unattended terminal coupled to the second network, wherein the transaction request information is derived from the transaction request and includes information identifying the user account;
the unattended terminal receiving the transaction request information from the second data network;
the unattended terminal sending a payment authorization request to the payment system, wherein the payment authorization request includes the information identifying the user account;
the unattended terminal receiving a payment authorization response to the payment authorization request; and
the unattended terminal acting in accordance with information included in the authorization response, including enabling a product and/or service to be vended in response to the authorization response information indicating that a payment has been authorized by the payment system.
